(19) United States
(12) Patent Application Publication
(10) Pub. No.: US 2008/0194855 A1
(43) Pub. Date: Aug. 14, 2008

(54) Metal Oxides Having A Permanent Positive Surface Charge Over A Wide Ph Range

(75) Inventors: Torsten Gottschalk-Gaudig, Mehring (DE); Christoph Briehn, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/720,551

(22) PCT Filed: Nov. 24, 2005
(86) PCT No.: PCT/EP2005/012587

§ 371 Date: May 31, 2007

(30) Foreign Application Priority Data
Dec. 1, 2004 (DE) 10 2004 057 997.0

(51) Int. Cl. C07F 7/10

(52) U.S. Cl. 556/407; 556/413; 556/418

(57) ABSTRACT

Metal oxide particles having bound quaternary ammonium groups exhibit a positive surface charge over a wide pH range, and are especially useful in toners and in preparing aqueous dispersions of low viscosity.

The invention relates to metal oxides which have a positive permanent surface charge over a wide pH range, to their preparation, and to aqueous dispersions thereof.

The surface charge properties and in particular the surface charge density of particulate metal oxides are important properties in the context of the use of these substances in aqueous dispersion, as free-flow assistants, and for charge control in toners, developers, and powder coating materials.

The stability of aqueous dispersions of the particulate metal oxides is critically determined by the amount of the surface charge density of the dispersed particles. Increasing surface charge density is accompanied by a rise in the dispersion's stability toward gelling and sedimentation. The uses of aqueous dispersions of particulate metal oxides include those as rheological additives for water-based adhesives, sealants and coating materials and for modifying the surface properties of solid substrates such as, for example, of fibers or paper.

Particulate metal oxides with electrostatically positive chargeability are employed in particular as constituents of developers and toners for the visualization of negative electrostatic charge images. A prerequisite in this application is a high, stable, uniform, positive triboelectric chargeability on the part of said particles.

The sign, the amount, and the density of the surface charge of particulate metal oxides are critically determined by the chemical structure of the particle surface. In the case of metal oxides such as silicon dioxides, aluminum oxides or titanium dioxides, surface hydroxyl groups are the charge-determining groups. Because of the acid-based properties of the hydroxyl groups, the surface charge of the particles is pH-dependent: that is, as a result of protonation of the hydroxyl groups, a low pH leads to a positive surface charge, while, as a result of deprotonation of the hydroxyl groups, a high pH leads to a negative surface charge. As a consequence of the pH dependency, the resulting surface charges are heavily dependent on the ambient conditions and are therefore not permanent. This can have an adverse effect on, for example, the stability of aqueous dispersions of said particulate metal oxides. Moreover, the low aqueous-phase pH values needed in order to generate a positive surface charge can lead to corrosion effects and may adversely affect the application properties of the aqueous dispersion.

EP 1247832 A1 describes the generation of positive surface charges through the adsorption of the cationic polyelectrolyte poly-DADMAC. A disadvantage there is that the polyelectrolyte is only physisorbed on the particle surface and therefore that the surface charge is dependent on the position of the adsorption-desorption equilibrium, and hence is not permanent.

For the purpose of generating positive triboelectric charges, aminosilanes, for example, as described for instance in DE 33 30 380, are fixed chemically to the particle surface. The triboelectric charges achieved with particles modified in this way, however, are again heavily dependent on the ambient conditions, such as the atmospheric humidity.

It was an object of the invention to overcome the disadvantages of the prior art, and in particular to provide particulate metal oxides having a positive permanent surface charge over a wide pH range.

This object is achieved by the invention.

The invention provides metal oxides which have a permanent positive surface charge in a pH range from 0 to 10 and have groups of the general formula I or Ia

—O₁₊ₙ—SiR¹₂₋ₙ—R²—B^{+X}⁻ (I),

O₁₊ₙ—SiR¹₂₋ₙ—CR¹₂—NR³₂⁺—(CH₂)ₓ-A X⁻ (Ia),

attached permanently to the surface, where
R¹ is a hydrogen atom or an Si—C-bonded C₁-C₂₀ hydrocarbon radical, preferably a C₁-C₈ hydrocarbon radical, more preferably a C₁-C₃ hydrocarbon radical, which if appropriate is monounsaturated or polyunsaturated and is unsubstituted or substituted by —CN, —NCO, —NR⁴₂, —COOH, —COOR⁴, -halo, -acryloyl, -epoxy, —SH, —OH or —CONR⁴₂, or is an aryl radical, or C₁-C₁₅ hydrocarbonoxy radical, preferably a C₁-C₈ hydrocarbonoxy radical, more preferably a C₁-C₄ hydrocarbonoxy radical, in each of which one or more nonadjacent methylene units may have been replaced by groups —O—, —CO—, —COO—, —OCO—, or —OCOO—, —S—, or —NR³— and in which one or more nonadjacent methine units may have been replaced by groups —N═, —N═N—, or —P═, each R¹ being identical or different,
R² is an Si—C-bonded C₁-C₂₀ hydrocarbon radical, preferably a C₁-C₈ hydrocarbon radical, more preferably a C₁-C₃ hydrocarbon radical, or an aryl radical, or C₁-C₁₅ hydrocarbonoxy radical, preferably a C₁-C₈ hydrocarbonoxy radical, more preferably a C₁-C₄ hydrocarbonoxy radical, in each of which one or more nonadjacent methylene units may have been replaced by groups —O—, —CO—, —COO—, —OCO—, or —OCOO—, —S—, or —NR³— and in which one or more nonadjacent methine units may have been replaced by groups —N═, —N═N— or —P═,
R³ is an N—C-bonded, monovalent, optionally divalent, C₁-C₂₀ hydrocarbon radical, preferably a C₁-C₈ hydrocarbon radical, more preferably a C₁-C₃ hydrocarbon radical, or an aryl radical, or C₁-C₁₅ hydrocarbonoxy radical, preferably a C₁-C₈ hydrocarbonoxy radical, more preferably a C₁-C₄ hydrocarbonoxy radical, in each of which one or more nonadjacent methylene units may have been replaced by groups —O—, —CO—, —COO—, —OCO—, or —OCOO—, —S— or —NR⁴— and in which one or more nonadjacent methine units may have been replaced by groups —N═, —N═N— or —P═, each R³ being identical or different,
B is a cationic group —NR³₃⁺, —N(R³)(═R³)⁺; —PR³₃⁺, said cationic groups possibly also being part of an aliphatic or aromatic heterocycle, such as of a pyridinium radical, of an N-alkyl-imidazolium radical such as N-methyl-imidazolium radical, N-alkyl-morpholinium, such as N-methyl-morpholinium,
X⁻ is an acid anion, and
R⁴ is a hydrogen atom or C₁-C₁₅ hydrocarbon radical, preferably a C₁-C₈ hydrocarbon radical and more preferably a C₁-C₃ hydrocarbon radical, or aryl radical, each R⁴ being identical or different,
A can be oxygen, sulfur or a group of the formula NR³,
x can adopt the values between 0 and 10, and
n is 0, 1 or 2,
   with a hydrodynamic equivalent diameter of the aggregates of 80-800 nm.

In this context it was extremely surprising, and in no way foreseeable for the skilled worker, that simply partially modifying the solid's surface with groups of the general formula I or Ia would give a permanent positive surface charge to the metal oxides over a wide pH range. Besides the cost saving achieved through lower quantities of modifying reagents used, a partial modification of the metal oxides is advantageous in particular for the use of said metal oxides for the purpose, for example, of papercoating, since a partial modification has only a minor detrimental effect on the adsorption capacity of the metal oxides.

These modified metal oxides are obtainable in principle in accordance with the following processes:
1. The invention also provides a process for preparing the metal oxides of the invention, wherein the unmodified metal oxides are reacted with silanes of the general formula II or IIa

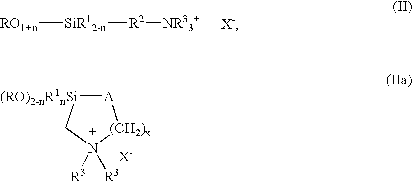

where
R is a C—O-bonded C₁-C₁₅ hydrocarbon radical, preferably a C₁-C₈ hydrocarbon radical, more preferably a C₁-C₃ hydrocarbon radical, or an acetyl radical, and R¹, R², R³, X⁻, A, n, and x are as defined above.
2. The invention also provides a process for preparing the metal oxides of the invention, wherein the metal oxides which on the surface carry groups of the general formula III

—O₁₊ₙ—SiR¹₂₋ₙ—R²—NR³₂ (III)
the metal oxides being preferably obtainable by reaction with the untreated metal oxides with silanes of the general formula IIIa

RO₁₊ₙ—SiR¹₂₋ₙ—R²—NR³₂ (IIa)
where R, R¹, R², and R³ are as defined above, are reacted with compounds of the general formula (IV)

R³—X (IV),
where R³ is as defined above and X is the above-mentioned C-bonded acid anion radical.
3. The invention also provides a process for preparing the metal oxides of the invention, wherein the metal oxides which on the surface carry groups of the general formula V

O₁₊ₙ—SiR¹₂₋ₙ—R²—Y (V)
the metal oxides being preferably obtainable by reaction of the untreated metal oxides with silanes of the general formula Va

RO₁₊ₙ—SiR¹₂₋ₙ—R²—Y (Va),
where R, R¹, and R² are as defined above and Y is —OH, —SH or —NR³₂, where R³ is as defined above, are reacted with glycidyltrimethylalkyl halides of the general formula VI

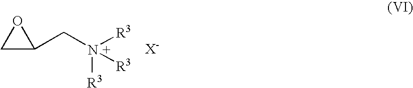

where R³ and X⁻ are as defined above.

Where appropriate it is possible, as well as the silanes of the general formulae II, IIa, IIIa, and Va, to make use preferably of further surface modifier reagents such as

(i) organosilanes and/or organosilazanes of the formula

R¹_{d}SiZ_{4-d} (VII)

and/or their partial hydrolysates,
where
each R¹ can be identical or different and is as defined above,
d is 1, 2 or 3, and
each Z can be identical or different and is halogen atom, monovalent Si—N-bonded nitrogen radicals, to which a further silyl radical may be attached, or is —OR⁴ or —OC(O)OR⁴, R⁴ being as defined above, or
(ii) linear, branched or cyclic organosiloxanes comprising units of the formula

R¹ₑ(OR)_{f}SiO_{(4-e-f)/2} (VIII)

where
each R and R¹ can be identical or different and has one of the definitions stated above for R or R¹, respectively,
e is 0, 1, 2 or 3, and
f is 0, 1, 2 or 3, with the proviso that the sum e+f is ≦3,
or
mixtures of (i) and (ii).

The organosilicon compounds which can be used in addition to the silanes of the general formulae II, IIa, IIIa, and Va for silylating the metal oxides may for example be mixtures of silanes or silazanes of the formula (VII), preference being given to those comprising methylchlorosilanes on the one hand or alkoxysilanes and, where appropriate, disilazanes on the other hand.

The silanes of the general formulae II, IIa, IIIa, and Va and the organosilicone compounds VII and VIII, respectively, can be used as a mixture or in succession.

Examples of R¹ are the radicals stated above, preference being given to the methyl, octyl, phenyl, and vinyl radical, and particular preference to the methyl radical.

Examples of R² are preferably the methyl, the ethyl, the propyl, and the octyl radical, preference being given to the methyl and the ethyl radical.

Examples of organosilanes of the formula (VII) are alkylchlorosilanes, such as methyltrichlorosilane, dimethyldichlorosilane, trimethylchlorosilane, octyl-methyldichlorosilane, octyltrichlorosilane, octadecyl-methyldichlorosilane, and octadecyltrichlorosilane, methylmethoxysilanes, such as methyltrimethoxysilane, dimethyldimethoxysilane, and trimethylmethoxysilane, methylethoxysilanes, such as methyltriethoxysilane, dimethyldiethoxysilane, and trimethylethoxysilane, methylacetoxysilanes, such as methyltriacetoxysilane, dimethyldiacetoxysilane, and trimethylacetoxysilane, phenylsilanes, such as phenyltrichlorosilane, phenyl-methyldichlorosilane, phenyldimethylchlorosilane, phenyltrimethoxysilane, phenylmethyldimethoxysilane, phenyldimethylmethoxysilane, phenyltriethoxysilane, phenylmethyldiethoxysilane, and phenyldimethylethoxy-silane,

vinylsilanes, such as vinyltrichlorosilane, vinyl-methyldichlorosilane, vinyldimethylchlorosilane, vinyl-trimethoxysilane, vinylmethyldimethoxysilane, vinyl-dimethylmethoxysilane, vinyltriethoxysilane, vinyl-methyldiethoxysilane, and vinyldimethylethoxysilane, disilazanes such as hexamethyldisilazane, divinyl-tetramethyldisilazane, and bis(3,3-trifluoropropyl)-tetramethyldisilazane, cyclosilazanes such as octa-methylcyclotetrasilazane, and silanols such as trimethylsilanol.

Preference is given to methyltrichlorosilane, dimethyldichlorosilane, and trimethylchlorosilane, or hexamethyldisilazane.

Examples of organosiloxanes of the formula (VIII) are linear or cyclic dialkylsiloxanes having an average number of dialkylsiloxy units of greater than 3. The dialkylsiloxanes are preferably dimethylsiloxanes. Particular preference is given to linear polydimethyl-siloxanes having the following end groups: trimethyl-siloxy, dimethylhydroxysiloxy, dimethylchlorosiloxy, methyldichlorosiloxy, dimethylmethoxysiloxy, methyl-dimethoxysiloxy, dimethylethoxysiloxy, methyldiethoxy-siloxy, dimethylacetoxysiloxy, methyldiacetoxysiloxy, and dimethylhydroxysiloxy groups, in particular having trimethylsiloxy or dimethylhydroxysiloxy end groups.

The aforementioned polydimethylsiloxanes preferably have a viscosity at 25° C. of 2 to 100 mPa·s.

Further examples of organosiloxanes are silicone resins, especially those which as alkyl groups contain methyl groups, particular preference being given to those which contain R¹₃SiO_{1/2} and SiO_{4/2} units, or to those which contain R₁SiO_{3/2} and optionally R¹₂SiO_{2/2} units, R¹ having one of the definitions stated above.

The aforementioned silicone resins preferably have a viscosity at 25° C. of 500 to 5000 mm²/s.

In the case of silicone resins having a viscosity of greater than 1000 mm²/s at 25° C., preference is given to those which can be dissolved in a readily technically manageable solvent, such as preferably alcohols such as methanol, ethanol, isopropanol, ethers such as diethyl ether, tetrahydrofuran, siloxanes such as hexamethyl-disiloxane, alkanes such as cyclohexane or n-octane, aromatics such as toluene or xylene, with a concentration above 10% by weight and with a mixture viscosity of less than 1000 mm²/s at a temperature of 25° C. under the pressure of the surrounding atmosphere.

Among the solid organosiloxanes, preference is given to those which dissolve in a technically manageable solvent (as defined above) with a concentration greater than 10% by weight and with a mixture viscosity of less than 1000 mm²/s at a temperature of 25° C.

The solid used, with OH groups on the surface, can be a metal with an oxidized surface, such as silicon, aluminum or iron, a mineral glass, such as quartz glass or window glass, or a metal oxide.

The base product (starting product) used for the surface modification is preferably a solid having an average particle size of <1000 μm, in particular an average primary particle size of from 5 to 100 nm. These primary particles may not exist in isolation but instead may be constituents of larger aggregates and agglomerates.

Preferred solids are metal oxides, more preferably silica. Preferably the metal oxide has a specific surface area of from 0.1 to 1000 m²/g (measured by the BET method in accordance with DIN 66131 and 66132), more preferably from 10 to 500 m²/g.

The metal oxide may comprise aggregates (as defined in DIN 53206) in the range of diameters from 100 to 1000 nm, with the metal oxide comprising agglomerates (as defined in DIN 53206) which are composed of aggregates and which as a function of the external shear load (e.g., as a result of the measuring conditions) may have sizes of from 1 to 1000 μm.

In order that it can be handled industrially the metal oxide is preferably an oxide with a covalent bonding component in the metal-oxygen bond, preferably an oxide in the solid aggregate state of the main group and transition group elements, such as of main group 3, such as boron, aluminum, gallium or indium oxide, or of main group 4, such as silicon dioxide, germanium dioxide, or tin oxide or dioxide, lead oxide or dioxide, or an oxide of transition group 4, such as titanium dioxide, zirconium oxide, or hafnium oxide. Other examples are stable oxides of nickel, of cobalt, of iron, of manganese, of chromium or of vanadium.

Particular preference is given to aluminum(III), titanium(IV), and silicon(IV) oxides, such as silica gels or silicas prepared wet-chemically—by precipitation, for example—or aluminum oxides, titanium dioxides or silicon dioxides prepared in elevated-temperature operations, such as, for example, pyro-genically prepared aluminum oxides, titanium dioxides or silicon dioxides, or silica.

Other solids are silicates, aluminates or titanates, or aluminum phyllosilicates, such as bentonites, such as montmorillonites, or smectites or hectorites.

Particular preference is given to pyrogenic (fumed) silica, which is prepared in a flame reaction from organosilicon compounds, e.g., from silicon tetrachloride or methyldichlorosilane, or hydro-trichlorosilane or hydromethyldichlorosilane, or other methylchlorosilanes or alkylchlorosilanes, as they are or in a mixture with hydrocarbons, or any desired volatilizable or sprayable mixtures of organosilicon compounds, as mentioned, and hydrocarbons, e.g., in an oxyhydrogen flame, or else in a carbon monoxide/oxygen flame. The silica can be prepared optionally with or without the further addition of water, in the purification step, for example; it is preferred not to add water.

Any desired mixtures of the solids stated may be used for the surface modification.

The pyrogenic silica preferably has a fractal surface dimension of preferably less than or equal to 2.3, more preferably less than or equal to 2.1, in particular from 1.95 to 2.05, the fractal surface dimension, Dₛ, being defined here as follows:

particle surface area A is proportional to particle radius R to the power of Dₛ.

The silica preferably has a fractal mass dimension Dₘ of preferably less than or equal to 2.8, more preferably greater than or equal to 2.3, very preferably from 1.7 to 2.1, as given in, for example, F. Saint-Michel, F. Pignon, A. Magnin, J. Colloid Interface Sci. 2003, 267, 314. The fractal mass dimension, Dₘ, is defined here as follows:

particle mass M is proportional to particle radius R to the power of Dₘ.

Preferably the unmodified silica has a density of surface silanol groups SiOH of less than 2.5 SiOH/nm², preferably less than 2.1 SiOH/nm², more preferably less than 2 SiOH/nm², very preferably from 1.7 to 1.9 SiOH/nm².

It is possible to use silicas prepared wet-chemically or at a high temperature (>1000° C.). Particular preference is given to silicas prepared pyrogenically. It is also possible to use hydrophilic silicas which come freshly prepared direct from the burner, have been stored, or have already been packaged in a commercially customary fashion.

It is additionally possible to use hydrophobicized metal oxides or silicas, e.g., commercially customary silicas.

Both uncompacted silicas, with bulk densities of <60 g/l, and compacted silicas, with bulk densities of >60 g/l, can be used.

Mixtures of different metal oxides or silicas can be used: for example, mixtures of metal oxides or silicas differing in BET surface area, or mixtures of metal oxides differing in degree of hydrophobicization or degree of silylation.

The metal oxide can be prepared in continuous or batchwise processes; the process for silylation may be composed of one or more steps. With preference the silylated metal oxide is prepared by means of a process in which the preparation operation takes place in separate steps: (A) first preparation of the hydrophilic metal oxide, (B) where appropriate, premodified metal oxide by known methods using silanes of the general formula IIIa and/or Va (path 2 and/or 3), then (C) silylation/modification of the metal oxide with (1) loading of the hydrophilic (path 1) or premodified (path 2 or 3) metal oxide with silanes of the general formula II or IIa or compounds of the general formula IV or VI, (2) reaction of the metal oxide with the compounds applied, and (3) purification of the metal oxide to remove excess compounds applied.

The surface treatment is preferably conducted in an atmosphere which does not lead to oxidation of the silylated metal oxide: that is, preferably less than 10% by volume oxygen, more preferably less than 2.5% by volume, the best results being obtained at less than 1% by volume oxygen.

Covering, reaction, and purification can be carried out as a batchwise or continuous operation. For technical reasons preference is given to a continuous reaction regime.

Covering (step C1) takes place preferably at temperatures of −30-250° C., preferably 20-150° C., more preferably 20-80° C.; the covering step is preferably carried out at 30-50° C.

The residence time is 1 min-24 h, preferably from 15 min to 240 min, with particular preference—for reasons of the space/time yield—from 15 min to 90 min.

The pressure at the covering stage ranges from a slight underpressure of down to 0.2 bar to an overpressure of 100 bar, preference being given on technical grounds to normal pressure—that is, unpressurized operation with respect to external/atmospheric pressure.

The silanes of the general formula II or IIa and/or compounds of the general formula IV or VI are preferably added in liquid form and in particular are mixed into the pulverulent metal oxide. The compounds can be admixed in pure form or as solutions in known, industrially employed solvents, such as, for example, alcohols such as methanol, ethanol or isopropanol, ethers such as diethyl ether, THF or dioxane, or hydro-carbons such as hexanes or toluene, for example. The concentration in the solution is 5%-95%, preferably 30%-95%, more preferably 50%-95% by weight. This admixing is preferably done by means of nozzle techniques, or comparable techniques, such as effective spraying techniques, such as spraying in 1-fluid nozzles under pressure (preferably from 5 to 20 bar), spraying in 2-fluid nozzles under pressure (preferably gas and liquid, 2-20 bar), ultrafine division with atomizers or gas/solid exchange assemblies with movable, rotating or static internals which permit homogeneous distribution of the silanes of the general formula II or IIa and/or the compounds of the general formula IV or VI with the pulverulent metal oxide.

Preferably the silanes of the general formula II or IIa and/or compounds of the general formula IV or VI are added as an ultrafinely divided aerosol, characterized in that the aerosol has a settling velocity of 0.1-20 cm/s.

Preferably the loading of the metal oxide and the reaction with the silanes of the general formula II or IIa and/or compounds of the general formula IV or VI take place under mechanical or gasborne fluidization. Mechanical fluidization is particularly preferred.

Gasborne fluidization can be by means of all inert gases which do not react with the silanes of the general formula II or IIa and/or compounds of the general formula IV or VI, with the metal oxide or with the silylated metal oxide—that is, which do not lead to side reactions, degradation reactions, oxidation events or flame or explosion phenomena, such as, preferably, N₂, Ar, other noble gases, CO₂, etc. The fluidizing gases are supplied preferably at superficial gas velocities of from 0.05 to 5 cm/s, with particular preference 0.5-2.5 cm/s.

Particular preference is given to mechanical fluidization, which takes place, without additional employment of gas beyond that used for inertization, by means of paddle stirrers, anchor stirrers, and other suitable stirring elements.

In one particularly preferred version, unreacted silanes of the general formula II or IIa and/or compounds of the general formula IV or VI and exhaust gases from the purification step are recycled to the step of covering and loading the metal oxide; this recycling may be partial or complete, accounting preferably for 10%-90% of the overall volume flow of the gases emerging from the purification step.

This takes place in suitably thermostated apparatus.

This recycling takes place preferably in non-condensed phase, i.e., in the form of gas or in the form of vapor. This recycling can take place as mass transport along a pressure equalization or as controlled mass transport with the standard industry gas transport systems, such as fans, pumps, and compressed-air membrane pumps. Since it is preferred to recycle the non-condensed phase it may be advisable to heat the recycle lines.

The recycling of the unreacted silanes of the general formula II or IIa and/or compounds of the general formula IV or VI and of the exhaust gases may be situated in this case preferably at between 5% and 100% by weight, based on their total mass, preferably between 30% and 80% by weight. Recycling may amount to between 1 and 200 parts per 100 parts of freshly used silane, preferably from 10 to 30 parts.

Recycling of the purification products from the silylation reaction to the covering stage is preferably continuous.

The reaction takes place preferably at temperatures of 40-200° C., preferably 40-160° C., and more preferably 80-150° C.

The reaction time is from 5 min to 48 h, preferably from 10 min to 4 h.

Where appropriate it is possible to add protic solvents, such as liquid or vaporizable alcohols or water; typical alcohols are isopropanol, ethanol, and methanol. It is also possible to add mixtures of the abovementioned protic solvents. It is preferred to add from 1% to 50% by weight of protic solvent, based on the metal oxide, more preferably from 5% to 25% by weight. Water is particularly preferred.

Optionally it is possible to add acidic catalysts, of acidic nature in the sense of a Lewis acid or of a Brönsted acid, such as hydrogen chloride, or basic catalysts, of basic nature, in the sense of a Lewis base or of a Brönsted base, such as ammonia or amines such as triethylamine. They are preferably added in traces, which means less than 1000 ppm. It is particularly preferred not to add any catalysts.

Purification takes place at a temperature of from 20 to 200° C., preferably from 50° C. to 180° C., more preferably from 50 to 150° C.

The purification step is preferably characterized by agitation, with preference being given particularly to slow agitation and slight mixing. The stirring elements are set and agitated advantageously in such a way that, preferably, mixing and fluidization occur, but not complete vortexing.

The purification step may additionally be characterized by an increased gas input, corresponding to a superficial gas velocity of preferably from 0.001 to 10 cm/s, more preferably from 0.01 to 1 cm/s. This can be done by means of all inert gases which do not react with the silanes of the general formula II or IIa and/or compounds of the general formula IV or VI, the metal oxide, or the silylated metal oxide, i.e., which do not lead to side reactions, degradation reactions, oxidation events or flame or explosion phenomena, such as, preferably, N₂, Ar, other noble gases, CO₂, etc.

In addition it is possible during the silylation or modification step or following the purification step to employ methods for the mechanical compaction of the metal oxides, such as, for example, press rollers, milling assemblies, such as edge runner mills and such as ball mills, continuously or batchwise, compaction by screws or worm mixers, worm compactors, briquetting machines, or compaction by suction withdrawal of the air or gas present, by means of suitable vacuum methods.

Particular preference is given to mechanical compaction during the silylating or modifying step, in step (II) of the reaction, by means of press rollers, above-mentioned milling assemblies such as ball mills, or compaction by means of screws, worm mixers, worm compactors and/or briquetting machines.

In a further particularly preferred procedure purification is followed by deployment of methods for the mechanical compaction of the metal oxide, such as compaction by suction withdrawal of the air or gas present, by means of suitable vacuum methods, or press rollers, or a combination of both methods.

Additionally it is possible in one particularly preferred procedure, following purification, to employ methods for deagglomerating the metal oxide, such as pin-disk mills, hammer mills, opposed-jet mills, impact mills or milling/classifying devices.

The silanes of the general formula II or IIa and/or compounds of the general formula IV or VI are used preferably in an amount of less than 15% by weight (based on the metal oxide), more preferably less than 10% by weight (based on the metal oxide), very preferably less than 8% by weight (based on the metal oxide), for a metal oxide surface area employed of 100 m²/g BET surface area (measured by the BET method in accordance with DIN 66131 and 66132).

In addition to silanes of the general formula II or IIa and/or compounds of the general formula IV or VI, the metal oxide may be reacted with a typical surface modifier agent, in particular a silylating agent.

Prepared with preference is a silica having a homogeneously modified surface, having an average primary particle size of less than 100 nm, preferably having an average primary particle size of from 5 to 50 nm, these primary particles existing not in isolation in the silica but instead being constituents of larger aggregates (as defined in accordance with DIN 53206) which have a diameter of from 80 to 800 nm and constitute agglomerates (as defined in accordance with DIN 53206) which, depending on the external shear load, have sizes from 1 to 500 μm, the silica having a specific surface area of from 10 to 400 m²/g (measured by the BET method in accordance with DIN 66131 and 66132), the silica having a fractal mass dimension Dₘ of less than or equal to 2.8, preferably less than or equal to 2.3, more preferably from 1.7 to 2.1, as given in, for example, F. Saint-Michel, F. Pignon, A. Magnin, J. Colloid Interface Sci. 2003, 267, 314.

Preferably the silica surface is permanently chemically modified with groups of the general formula I or Ia. This means here that the density of surface silanol groups SiOH is less than 1.8 SiOH/nm², preferably between 0.3 and 1.7 SiOH/nm², more preferably between 0.3 and 1.6 SiOH/nm² and very preferably between 0.3 and 1.5 SiOH/nm².

The metal oxides of the invention preferably have a carbon content of less than 10%, more preferably less than 8%, very preferably less than 6% by weight.

The metal oxides of the invention, furthermore, are characterized in that they have a permanent positive surface charge. The surface charge of the metal oxides is greater than 1 C/g, preferably greater than 2.5 C/g, and very preferably greater than 5 C/g, measured in each case by means of charge titration on a Mütek PCD 03 pH (from Mütek) in combination with a Titrino 702 SM titroprocessor (from Metrohm) and using 0.001N PES-Na (sodium polyethenesulfonate) solution as the titration solution.

The silicas of the invention are further characterized in that they have a positive ZETA potential over a wide pH range. In general, for the isoelectric point of silicas (generally SiO₂), i.e., the pH at which the ZETA potential has a value of zero, a pH of <4 is stated, as given for example in M. Kosmulski, J. Colloid Interface Sci. 2002, 253, 77. This means that only at a pH <4 does noninventive silica have a positive ZETA potential. The silicas of the invention have an isoelectric point at a pH >4, preferably at a pH >4.5, and very preferably at a pH >5.

The invention further provides aqueous dispersions comprising the metal oxides of the invention.

For the purpose of preparing the dispersions of the invention, the metal oxides of the invention are added to the liquid and incorporated by spontaneous wetting, or by shaking, such as with a tumble mixer, or a high speed mixer, or by stirring, such as by means of cross-arm stirrers or dissolvers. At low particle concentrations below 10% by weight, simple stirring is generally sufficient for the incorporation of particles into the liquid. It is preferred to incorporate the particles into the liquid at a high shear rate. Subsequently to and/or parallel with the incorporation, the particles are dispersed. Preference is given to parallel dispersing. This can be accomplished by means of a dispersing system in the first container, or by pumped circulation in external pipelines containing a dispersing element, pumping taking place from the container, preferably with closed-loop recycling, into the container. By means of a partial recycle, and partial continuous removal, this operation can preferably be made continuous.

Suitable for this purpose are preferably high-speed stirrers, high-speed dissolvers, with peripheral speeds for example of 1-50 m/s, high-speed rotor-stator systems, Sonolators, shearing gaps, nozzles, and ball mills.

Particularly suitable for dispersing the metal oxides of the invention in the dispersion of the invention is the use of ultrasound in the range from 5 Hz to 500 kHz, preferably 10 kHz to 100 kHz, very preferably 15 kHz to 50 kHz; the ultrasonic dispersion may take place continuously or batchwise. This can be done by means of individual ultrasonic transducers, such as ultrasound tips, or in continuous-flow systems, containing one or more ultrasonic transducers, where appropriate in systems separated by a pipeline or pipe wall.

The preparation of the invention can take place in batchwise and in continuous processes. Continuous processes are preferred.

The dispersion of the invention can of course also be produced otherwise. It has, however, been found that the procedure is critical and that not all modes of preparation produce stable dispersions.

The processes of the invention have the advantage that they are very simple to carry out and that aqueous dispersions having very high solids contents can be produced.

The amount of metal oxides of the invention in the dispersions of the invention is preferably 5%-60%, more preferably 5%-50%, very preferably 10%-40%, and with very particular preference 15%-35% by weight.

The aqueous dispersions of the invention containing high levels of metal oxides of that invention are characterized in particular in that low-viscosity dispersions can be obtained. This means that dispersions having a metal oxide content of preferably 5% to 60% by weight have a viscosity of less than 1000 mPas, preferably a viscosity of 800 to 10 mPas, more preferably a viscosity of 700 to 50 mPas, the viscosity being measured with a cone/plate sensor system with a measurement slot of 105 μm, at 25° C. and with a shear rate of 10 s⁻¹.

The aqueous dispersions of the invention containing high levels of metal oxides of the invention are characterized additionally in that they exhibit excellent storage stability. This means that the viscosity of a dispersion after a storage time of 4 weeks at 40° C. has risen by not more than a factor of 1.5, preferably not more than a factor of 1.25, more preferably not more than a factor of 1.1, and very preferably not more than a factor of 1, as compared with the viscosity immediately after preparation of the dispersion, the viscosity being measured with a cone/plate sensor system with a 105 μm measuring slot, at 25° C. with a shear rate of 10 s⁻¹.

The aqueous dispersions of the invention containing high levels of metal oxides of the invention are further characterized in that they exhibit excellent storage stability. This means that the dispersions after a storage time of 4 weeks at 40° C. have a yield stress of less than 100 Pa, preferably less than 10 Pa, more preferably less than 1 Pa, and very preferably less than 0.1 Pa, measured in each case by the vane method at 25° C. in accordance with Q. D. Nguyen, D. Boger, J. Rheol. 1985, 29, 335.

The dispersions of the invention are further characterized in that the dispersed particles are in the form of finely divided sinter aggregates. These sinter aggregates are characterized in that, in the case of particle size determination by means of quasi-elastic light scattering, the measured hydrodynamic equivalent diameter is greater by a factor of at least 2, preferably by a factor of 2.5 to 50, more preferably by a factor of 2.8 to 30, based in each case on a specific surface area of 100 m²/g—in the case of a smaller or larger surface area, the factor decreases or increases linearly in accordance—than the diameter of the primary particles obtainable arithmetically in accordance with the formula a=6/A_{BET}*d, where A_{BET} is the specific BET surface area of the initial hydro-philic silica, as measured by means of nitrogen adsorption in accordance with DIN 66131, and d is the density of the primary particles.

The dispersions of the invention are further characterized in that if desired they comprise fungicides or bactericides, such as methyliso-thiazolones or benzisothiazolones.

The metal oxides of the invention and their aqueous dispersions of the invention are additionally characterized in that they are suitable for producing papercoatings, of the kind used, for example, for high-gloss photographic papers.

The metal oxides of the invention are further characterized in that they prevent deposition or caking in pulverulent systems, under the effect of moisture, for example, but also do not tend toward reagglomeration, and hence toward unwanted separation, but instead keep powders flowable and therefore produce mixtures which are stable under load and stable on storage. This applies particularly to use in nonmagnetic and magnetic toners and developers and charge control agents, e.g., in contactless or electrophotographic printing/reproduction processes, which may be 1-component and 2-component systems. This also applies in pulverulent resins which are used as coating systems.

The invention relates further to the use of the metal oxides of the invention in systems of low to high polarity, as a viscosity-imparting component. This relates to all solvent-free, solvent-containing, film-forming coating compositions, rubberlike to hard coatings, adhesives, sealing and casting compounds, and other, comparable systems.

The metal oxides of the invention can be used in systems such as:
epoxy systems
polyurethane (PU) systems
vinyl ester resins
unsaturated polyester resins
low-solvent resin systems, called high-solids systems
solvent-free resins which are applied in powder form as, for example, coating materials.

As a rheological additive to these systems the metal oxides of the invention provide the requisite viscosity, pseudoplasticity, and thixotropy and provide a yield stress which is sufficient for the composition to be able to stand on vertical surfaces.

The metal oxides of the invention can be used especially as a Theological additive and reinforcing filler in noncrosslinked and crosslinked silicone systems, such as silicone elastomers which are composed of silicone polymers, such as polydimethylsiloxanes, fillers, and further additives. These systems can be crosslinked, for example, with peroxides, or crosslinked by way of addition reactions, the so-called hydrosilylation reaction, between olefinic groups and Si—H groups, or by way of condensation reactions between silanol groups, such as those reactions which come about on exposure to water.

The metal oxides of the invention may further be used specifically as a reinforcing filler in water-based coatings, adhesives, sealing and casting compounds, and other, comparable systems, for the purpose of improving the mechanical properties of the fully cured system. On the basis of the special properties of the metal oxides of the invention, it is possible to realize high fill levels of metal oxides in the uncured systems, without an excessive increase in the viscosity.

The metal oxides of the invention and the dispersions of the invention may also be used to stabilize particle-stabilized emulsions, known as Pickering emulsions.

The invention additionally provides toners, developers, and charge control agents which comprise the inventive metal oxides. Examples of such developers and toners are magnetic 1-component and 2-component toners, and also nonmagnetic toners. These toners may be composed of resins, such as styrene resins and acrylic resins, and may be ground preferably to particle distributions of 1-100 μm, or can be resins which have been prepared in polymerization processes in dispersion or emulsion or solution or in bulk at particle distributions of preferably 1-100 μm. The silicas of the invention are preferably used to improve and control the powder flow behavior and/or to regulate and control the triboelectric charge properties of the toner or developer. Toners and developers of this kind can be used with preference in electrophotographic printing and press processes, and can also be employed in direct image transfer processes.

The composition of a toner is typically as follows:
Solid resin binder which is sufficiently hard for a powder to be produced from it, preferably having a molecular weight of more than 10 000, preferably with a fraction of polymer with a molecular weight below 10 000 of less than 10% by weight, e.g., a polyester resin which may be a cocondensate of diol and carboxylic acid, carboxylic ester or carboxylic anhydride, having an acid number, for example, of 1-1000, preferably of 5-200, or may be a polyacrylate or a polystyrene, or mixtures, or copolymers thereof, and having an average particle diameter of less than 20 μm, preferably less than 15 μm, more preferably less than 10 μm.

The toner resin may comprise alcohols, carboxylic acids, and polycarboxylic acid.
Colorants customary in the art, such as black carbon black, pigmentary carbon black, cyan dyes, magenta dyes, and yellow dyes.
Typically positive charge control agents: charge control additives of the nigrosine dye type, for example, or triphenylmethane dyes substituted by tertiary amines, or quaternary ammonium salts such as CTAB (cetyltrimethylammonium bromide=hexadecyl-trimethylammonium bromide), or polyamines, typically less than 5% by weight.
Optionally negative charge control agents: charge control additives such as metal azo dyes, or copper phthalocyanine dyes, or metal complexes, for example, of alkylated salicylic acid derivatives or benzoic acid, particularly with boron or aluminum, in the amounts required, typically less than 5% by weight.
If desired it is possible, in order to prepare magnetic toners, to add magnetic powders, such as, for example, powders which can be magnetized in a magnetic field, such as ferromagnetic substances, such as iron, cobalt, nickel, alloys, or compounds such as magnetite, hematite or ferrite.
Optionally it is also possible to add developers, such as iron powder, glass powder, nickel powder, ferrite powder.
Metal oxides of the invention are used in amounts, based on a solid resin binder with an average particle diameter of 20 μm, of greater than 0.01% by weight, preferably greater than 0.1% by weight. As the average particle diameter of the binder goes down, the amounts of metal oxide required become, generally speaking, greater, with the amount of metal oxide required increasing in inverse proportion to the particle diameter of the binder. In any case, however, the amount of metal oxide is preferably less than 5% by weight based on binder resin.
Further inorganic additions, such as fine and coarse silicon dioxides, including those with an average diameter of from 100 to 1000 nm, aluminum oxides, such as pyrogenic aluminas, titanium dioxides, such as pyrogenic or anatase or rutile, zirconium oxides.
Waxes, such as paraffinic waxes having 10-500 carbon atoms, silicone waxes, olefinic waxes, waxes having an iodine number of <50, preferably <25, and a hydrolysis number of 10-1000, preferably 25-300.

The toner can be used in various development processes, such as for electrophotographic image production and reproduction, such as magnetic brush processes, cascades processes, use of conductive and nonconductive magnetic systems, powder cloud processes, development in impression, and others.

All of the above symbols in the above formulae have their definitions in each case independently of one another.

### EXAMPLES

### Example 1

At a temperature of 25° C. under N₂ inert gas 100 g of hydrophilic SILICA, having a moisture content of <1% and an HCl content of <100 ppm and having a specific surface area of 300 m²/g (measured by the BET method in accordance with DIN 66131 and 66132) (available under the name WACKER HDK T30 from Wacker-Chemie GmbH, Munich, D), are admixed, by atomization through a single-fluid nozzle (pressure: 5 bar), with 11.5 g of a 50% strength methanolic solution of the silane of the general formula II, in which R is a —CH₃ group, R² is a —CH₂—CH₂—CH₂— group, R³ is a —CH₃ group, X is Cl, and n=2, and 0.5 g of NEt₃ in solution in 5 ml of MeOH. The SILICA thus covered is further fluidized by means of stirring at a temperature of 25° C. with a residence time of 0.25 hour, and then reacted at 120° C. in a 100 l drying cabinet under N₂ with a residence time of 4 h. This gives a hydrophobic white SILICA powder with a homogeneous layer of silylating agent.

The analytical data are set out in Table 1.

### Example 2

At a temperature of 25° C. under N₂ inert gas 100 g of hydrophilic SILICA, having a moisture content of <1% and an HCl content of <100 ppm and having a specific surface area of 300 m²/g (measured by the BET method in accordance with DIN 66131 and 66132) (available under the name WACKER HDK T30 from Wacker-Chemie GmbH, Munich, D) are admixed, by atomization through a single-fluid nozzle (pressure: 5 bar), with 46 g of a 50% strength methanolic solution of the silane of the general formula II, in which R is a —CH₃ group, R² is a —CH₂—CH₂—CH₂— group, R³ is a —CH₃ group, X is Cl, and n=2, and 0.5 g of NEt₃ in solution in 5 ml of MeOH. The SILICA thus covered is further fluidized by means of stirring at a temperature of 25° C. with a residence time of 0.25 hour, and then reacted at 120° C. in a 100 l drying cabinet under N₂ with a residence time of 4 h. This gives a hydrophobic white SILICA powder with a homogeneous layer of silylating agent.

The analytical data are set out in Table 1.

### Example 3

At a temperature of 25° C. under N₂ inert gas 100 g of hydrophilic SILICA, having a moisture content of <1% and an HCl content of <100 ppm and having a specific surface area of 150 m²/g (measured by the BET method in accordance with DIN 66131 and 66132) (available under the name WACKER HDK V15 from Wacker-Chemie GmbH, Munich, D), are admixed, by atomization through a single-fluid nozzle (pressure: 5 bar), with 5.75 g of a 50% strength methanolic solution of the silane of the general formula II, in which R is a —CH₃ group, R² is a —CH₂—CH₂—CH₂— group, R³ is a —CH₃ group, X is Cl, and n=2, and 0.25 g of NEt₃ in solution in 5 ml of MeOH. The SILICA thus covered is further fluidized by means of stirring at a temperature of 25° C. with a residence time of 0.25 hour and then reacted at 120° C. in a 100 l drying cabinet under N₂ with a residence time of 4 h. This gives a hydrophobic white SILICA powder with a homogeneous layer of silylating agent.

The analytical data are set out in Table 1.

### Example 4

At a temperature of 25° C. under N₂ inert gas 100 g of hydrophilic SILICA, having a moisture content of <1% and an HCl content of <100 ppm and having a specific surface area of 300 m²/g (measured by the BET method in accordance with DIN 66131 and 66132) (available under the name WACKER HDK T30 from Wacker-Chemie GmbH, Munich, D), are admixed, by atomization through a single-fluid nozzle (pressure: 5 bar), with 23.0 g of a 50% strength methanolic solution of the silane of the general formula II, in which R is a —CH₃ group, R² is a —CH₂—CH₂—CH₂— group, R³ is a —CH₃ group, X is Cl, and n=2, and 0.5 g of NEt₃ in solution in 5 ml of MeOH. The SILICA thus covered is further fluidized by means of stirring at a temperature of 25° C. with a residence time of 0.25 hour, and then reacted at 120° C. in a 100 l drying cabinet under N₂ with a residence time of 4 h. This gives a hydrophobic white SILICA powder with a homogeneous layer of silylating agent.

The analytical data are set out in Table 1.

### Example 5

In a continuous apparatus at a temperature of 30° C. under N₂ inert gas a mass flow of 500 g/h of hydrophilic SILICA, having a moisture content of <1% and an HCl content of <100 ppm and having a specific surface area of 300 m²/g (measured by the BET method in accordance with DIN 66131 and 66132) (available under the name WACKER HDK T30 from Wacker-Chemie GmbH, Munich, D), is admixed with 115 g/h of a 50% strength methanolic solution of the silane of the general formula II, in which R is a —CH₃ group, R² is a —CH₂—CH₂—CH₂— group, R³ is a —CH₃ group, X is Cl, and n=2, which contains 2.2 g of NEt₃/100 ml of solution, the admixture taking place in liquid, very finely divided form by atomization through a single-fluid nozzle (pressure: 10 bar). The SILICA thus covered is reacted at a temperature of 100° C. with a residence time of 1 hour and at the same time is fluidized further by means of stirring, and then is purified in a dryer at 120° C. with a residence time of 1 hour.

This gives a hydrophobic white SILICA powder with a homogeneous layer of silylating agent.

The analytical data are set out in Table 1.

### Example 6

At a temperature of 25° C. under N₂ inert gas 100 g of hydrophilic SILICA, having a moisture content of <1% and an HCl content of <100 ppm and having a specific surface area of 300 m²/g (measured by the BET method in accordance with DIN 66131 and 66132) (available under the name WACKER HDK T30 from Wacker-Chemie GmbH, Munich, D), are admixed, by atomization through a single-fluid nozzle (pressure: 5 bar), with a solution of 18 g of the silane of the general formula II, in which R is a —CH₃ group, R² is a —CH₂— group, R³ is a —CH₃ group, x is Cl, and n=2, in 20 ml of MeOH. The SILICA thus covered is further fluidized by means of stirring at a temperature of 25° C. with a residence time of 0.25 hour, and then reacted at 120° C. in a 100 l drying cabinet under N₂ with a residence time of 4 h. This gives a hydrophobic white SILICA powder with a homogeneous layer of silylating agent.

The analytical data are set out in Table 1.

### Example 7

At a temperature of 25° C. under N₂ inert gas 100 g of hydrophilic SILICA, having a moisture content of <1% and an HCl content of <100 ppm and having a specific surface area of 200 m²/g (measured by the BET method in accordance with DIN 66131 and 66132) (available under the name WACKER HDK N20 from Wacker-Chemie GmbH, Munich, D), are admixed, by atomization through a single-fluid nozzle (pressure: 5 bar), with a solution of 12 g of the silane of the general formula IIa, in which R¹ is a —CH₃ group, R³ is a —CH₃ group, X is Cl, A=0; x=2 and n=0, and 0.25 g of NEt₃ in 20 ml of MeOH. The SILICA thus covered is further fluidized by means of stirring at a temperature of 25° C. with a residence time of 0.25 hour, and then reacted at 120° C. in a 100 l drying cabinet under N₂ with a residence time of 4 h.

This gives a hydrophobic white SILICA powder with a homogeneous layer of silylating agent.

The analytical data are set out in Table 1.

TABLE 1
Analytical data of the SILICA of Examples 1 to 7

| | | Residual | Charge | ξ potential mV | IEP |
|---|---|---|---|---|---|
| Example | % C | SiOH % | C/g | (pH = 4.0) | (pH) |
| 1 | 2.0 | 78 | +12.6 | +22 | 7.3 |
| 2 | 5.7 | 27 | +50.3 | +25 | 8.7 |
| 3 | 1.1 | 72 | +6.1 | +21 | 7.1 |
| 4 | 3.4 | 58 | +23.2 | +21 | 8.3 |
| 5 | 3.5 | 76 | +10.7 | +22 | 7.1 |
| 6 | 3.9 | 61 | +11.3 | +24 | 8.0 |
| 7 | 4.5 | 33 | +31.5 | +22 | 8.4 |

### Description of Analytical Methods

1. Carbon content (% C)
   Elemental analysis for carbon; combustion of the sample at >1000° C. in a stream of O₂, detection and quantification of the resulting CO₂ by IR; instrument: LECO 244
2. Residual amount of non-silylated SILICA silanol groups
   Method: Acid-based titration of the silica in suspension in 50:50 water/methanol; titration in the range above the pH range of the isoelectric point and below the pH range of the dissolution of the silica
   untreated silica with 100% SiOH (SILICA surface silanol groups): SiOH-phil=2 SiOH/nm² silylated silica: SiOH-silyl
   residual silica silanol content: % SiOH═SiOH-silyl/SiOH-phil*100% (in analogy to G. W. Sears Anal. Chem, 28 (12), (1950), 1981)
3. Charge density
   Charge-titration on a Mütek PCD 03 pH (from Mütek) in combination with a Titrino 702 SM titroprocessor (from Metrohm) using 0.001n PES-Na (sodium polyethenesulfonate) solution as the titration solution
4. ZETA potential
   Measured by means of a Zetasizer Nano ZS in the pH range 3-9; setting of the pH value by means of 1 M aqueous HCl or NaOH solution.

### Example 8

### Preparing an Aqueous Dispersion

A high-performance mixer, Unimix LM6 from Ekato with a capacity of 6 l, was charged with 4.0 l of fully demineralized (FD) water. With stirring and with the rotor-stator assembly running, 1000 g of a silica corresponding to Example 5 were metered in over a period of 30 min. The mixture was then subjected to intensive shearing for 1 h, in the course of which the temperature rose to approximately 45° C.

This gave a highly mobile dispersion. The analytical data of the dispersion are set out in Table 2.

TABLE 2
Analytical data of the dispersion of Example 8

| | Solids | | Viscosity | Viscosity |
|---|---|---|---|---|
| | content | | (10 s⁻¹; 1 h); | (10 s⁻¹; 28 d; |
| | (%) | pH | mPas | 40° C.); mPas |
| Example 8 | 19.8 | 4.8 | 120 | 130 |

### Example 9

### Charge Behavior of the SILICA

50 g portions of a ferrite carrier having an average particle diameter of 80 μm are mixed with 0.5 g portions of the SILICAs from Examples 3 and 4 at RT by shaking in a 100 ml PE vessel for 15 minutes. Prior to measurement, these mixtures are activated on a roller bed for 5 minutes at 64 rpm in a sealed 100 ml PE vessel. Using a “hard-blow-off cell” (approximately 3 g of SILICA, capacity 10 nF, 45 μm screen, air flow 1 l/min, air pressure 2.4 kPa, measurement time 90 s) (EPPING GmbH, D-85375 Neufahrn) the triboelectric charging behavior of the SILICA is measured as the ratio of SILICA charge to SILICA mass (q/m).

TABLE 3

| | Charge behavior q/m against |
|---|---|
| Example | ferrite [μC/g] |
| Carrier + Example 2 | +138 |

### Example 10

### Flow and Charge Behavior of SILICA Toner

100 g of a SILICA-free magnetic 1-component dry toner of the negatively charging “crushed” type, based on styrene-methacrylate copolymer, with an average particle size of 14 μm (obtainable, for example, from IMEX, Japan) are mixed with 0.4 g of a SILICA according to Examples 3-4 in a tumble mixer (e.g., Turbular) at RT for 1 hour. After a toner exposure time of 20 minutes (corresponding to the loading experienced after 1000 copying operations), the charging (charge per mass) of the ready-produced SILICA toner and the flow behavior (mass flow) of the ready-produced SILICA toner to the developing roller are measured in a “q/m mono” electrometer/flow tester (EPPING GmbH, D-85375 Neufahrn).

TABLE 4

| | Toner charge | Flow behavior |
|---|---|---|
| Example | [μC/g] | [mg] |
| SILICA-free | +1.20 | 18 |
| toner | | |
| Toner + Example 2 | +2.0 | 38 |

1.-13. (canceled)

14. Metal oxide particles having a permanent positive surface charge in a pH range from 0 to 10 comprising groups of the formula I or Ia
—O₁₊ₙ—SiR¹₂₋ₙ—R²—B⁺X⁻ (I),
—O₁₊ₙ—SiR¹₂₋ₙCR¹₂—NR³₂⁺—(CH₂)ₓ-A X⁻ (Ia),
attached permanently to the metal oxide surface, where
R¹ is a hydrogen atom, an Si—C-bonded C₁-C₂₀ hydrocarbon radical, monounsaturated or polyunsaturated, unsubstituted or substituted by —CN, —NCO, —NR⁴₂, —COOH, —COOR⁴, -halo, -acryloyl, -epoxy, —SH, —OH or —CONR⁴₂, an aryl radical or C₁-C₁₅ hydrocarbonoxy radical; in each of which one or more nonadjacent methylene units are optionally replaced by groups —O—, —CO—, —COO—, —OCO—, or —OCOO—, —S—, or —NR³— and in which one or more nonadjacent methine units are optionally replaced by groups —N═, —N═N—, or —P═, each R¹ being identical or different,
R² is an Si—C-bonded C₁-C₂₀ hydrocarbon radical, an aryl radical; or C₁-C₁₅ hydrocarbonoxy radical, in each of which one or more nonadjacent methylene units are optionally replaced by groups —O—, —CO—, —COO—, —OCO—, or —OCOO—, —S—, or —NR³— and in which one or more nonadjacent methine units are optionally replaced by groups —N═, —N═N— or —P═,
R³ is an N—C-bonded, monovalent or divalent C₁-C₂₀ hydrocarbon radical, an aryl radical, or C₁-C₁₅ hydrocarbonoxy radical, in each of which one or more nonadjacent methylene units are optionally replaced by groups —O—, —CO—, —COO—, —OCO—, or —OCOO—, —S— or —NR⁴— and in which one or more nonadjacent methine units are optionally replaced by groups —N═, —N═N— or —P═, each R³ being identical or different,
B is a cationic group —NR³₃⁺, —N(R³)(═R³)⁺; —PR³₃⁺, said cationic groups optionally part of an aliphatic or aromatic heterocycle,
X⁻ is an acid anion, and
R⁴ is a hydrogen atom, C₁-C₁₅ hydrocarbon radical or aryl radical, each R⁴ being identical or different,
A is oxygen, sulfur or a group of the formula NR³,
x has a value between 0 and 10 inclusively, and
n is 0, 1 or 2,
the metal oxide having a hydrodynamic equivalent diameter of aggregates of 80-800 nm.

15. The metal oxide particles of claim 14, wherein the metal oxide particles have a charge of greater than or equal to +1 C/g.

16. The metal oxide particles of claim 14, wherein the metal oxide particles are silicon dioxide.

17. The silicon dioxide particles of claim 16, wherein the silicon dioxide particles have a residual silanol content of 0.3 to 1.7 silanol groups/nm².

18. The silicon dioxide particles of claim 16, wherein the silicon dioxide particles have an isoelectric point at a pH greater than 4.

19. The silicon dioxide particles of claim 16, wherein the silicon dioxide particles have a zeta potential at a pH of 4 of greater than +5 mV.

20. An aqueous dispersion of a metal oxide particle of claim 14, wherein the amount of metal oxide particles is 5%-60% by weight.

21. The aqueous dispersion of claim 20, wherein the viscosity of the dispersion is less than 1000 mPas at 25° C.

22. The aqueous dispersion of claim 20, wherein after a storage time of 4 weeks at 40° C., the dispersion has a yield stress of less than 100 Pa as measured using the vane method at 25° C.

23. A process for preparing metal oxides of claim 14, wherein an unmodified metal oxide is reacted with a silane of the general II or IIa 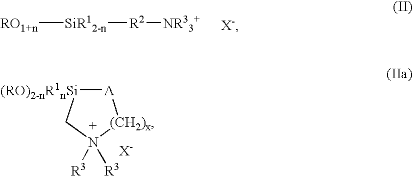
where
R is a C—O-bonded C₁-C₁₅ hydrocarbon radical or an acetyl radical.

24. A process for preparing a metal oxide of claim 14, wherein the metal oxides carry groups of the formula III on the surface
—O₊ₙ—SiR¹₂₋ₙ—R²—NR³₂ (III),
are reacted with compounds of the formula (IV)
R³—X (IV),
X is a C-bonded acid anion radical.

25. A process for preparing a metal oxide of claim 14, wherein the metal oxides carry groups of the formula III on the surface
—O₁₊ₙ—SiR¹₂₋ₙ—R²—Y (V)
where Y is —OH, —SH or —NR³₂, and are reacted with glycidyltrimethylalkyl halides of the formula VI

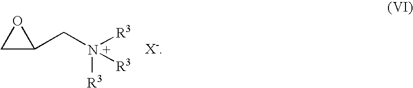

26. A toner, developer, or charge control agent comprising one or more metal oxides of claim 14.
